(19) United States
(12) Patent Application Publication
(10) Pub. No.: US 2013/0024879 A1
(43) Pub. Date: Jan. 24, 2013

(54) Measuring Television Advertisement Exposure Rate and Effectiveness

(71) Applicants: Sean Michael Bruich, Palo Alto, CA (US); Bradley Hopkins Smallwood, Palo Alto, CA (US)

(72) Inventors: Sean Michael Bruich, Palo Alto, CA (US); Bradley Hopkins Smallwood, Palo Alto, CA (US)

(21) Appl. No.: 13/188,383

(22) Filed: Jul. 21, 2011

(51) Int. Cl. H04N 21/24

(52) U.S. Cl. 725/9

(57) ABSTRACT

In one embodiment, a social networking system models a number of exposures to an advertisement for a concept for a set of users, sample from the set of users attitudinal data toward the concept, and determine effectiveness of the advertisement by evaluating the attitudinal data against the number of exposures to the advertisement.

### TECHNICAL FIELD

The present disclosure generally relates to advertising, and more particularly, to methods of modeling advertisement exposure and evaluating attitudinal data of users.

### BACKGROUND

A social networking system, such as a social networking website, enables its users to interact with it and with each other through the system. The social networking system may create and store a record, often referred to as a user profile, in connection with the user. The user profile may include a user's demographic information, communication channel information, and personal interest. The social networking system may also create and store a record of a user's relationship with other users in the social networking system (e.g., social graph), as well as provide services (e.g., wall-posts, photo-sharing, or instant messaging) to facilitate social interaction between users in the social networking system.

An advertiser may create a television advertisement or a series of television advertisements for a product, a brand, and/or a service. Television advertisements are often presented during a television program or between two television programs.

### SUMMARY

Particular embodiments relate to methods of modeling a number of exposures to an advertisement for a concept for a set of users, sampling from the set of users attitudinal data toward the concept, and determining effectiveness of the advertisement by evaluating the attitudinal data against the number of exposures to the advertisement. In some embodiments, the information provided by the invention facilitates an understanding of television advertising in a manner that parallels online advertising and further facilitates advertising budget allocation decisions between online and television media. These and other features, aspects, and advantages of the disclosure are described in more detail below in the detailed description and in conjunction with the following figures.

### BRIEF DESCRIPTION OF THE DRAWINGS

FIG. 1 illustrates an example social networking system.

FIG. 2 illustrates an example method of determining effectiveness of an television advertisement.

FIG. 3 illustrates an example episode-specific question.

FIG. 3A illustrates an example attitudinal question.

FIGS. 3B and 3C illustrate example graphs that may be generated based on the exposure modeling operating described herein.

FIG. 4 illustrates an example network environment.

FIG. 5 illustrates an example computer system.

### DETAILED DESCRIPTION

The invention is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

A social networking system, such as a social networking website, enables its users to interact with it, and with each other through, the system. Typically, to become a registered user of a social networking system, an entity, either human or non-human, registers for an account with the social networking system. Thereafter, the registered user may log into the social networking system via an account by providing, for example, a login ID or username and password. As used herein, a “user” may be an individual (human user), an entity (e.g., an enterprise, business, or third party application), or a group (e.g., of individuals or entities) that interacts or communicates with or over such a social network environment.

When a user registers for an account with a social networking system, the social networking system may create and store a record, often referred to as a “user profile”, in connection with the user. The user profile may include information provided by the user and information gathered by various systems, including the social networking system, relating to activities or actions of the user. For example, the user may provide his name, profile picture, contact information, birth date, gender, marital status, family status, employment, education background, preferences, interests, and other demographical information to be included in his user profile. The user may identify other users of the social networking system that the user considers to be his friends. A list of the user's friends or first degree contacts may be included in the user's profile. Connections in social networking systems may be in both directions or may be in just one direction. For example, if Bob and Joe are both users and connect with each another, Bob and Joe are each connections of the other. If, on the other hand, Bob wishes to connect to Sam to view Sam's posted content items, but Sam does not choose to connect to Bob, a one-way connection may be formed where Sam is Bob's connection, but Bob is not Sam's connection. Some embodiments of a social networking system allow the connection to be indirect via one or more levels of connections (e.g., friends of friends). Connections may be added explicitly by a user, for example, the user selecting a particular other user to be a friend, or automatically created by the social networking system based on common characteristics of the users (e.g., users who are alumni of the same educational institution). The user may identify or bookmark websites or web pages he visits frequently and these websites or web pages may be included in the user's profile.

The user may provide information relating to various aspects of the user (such as contact information and interests) at the time the user registers for an account or at a later time. The user may also update his or her profile information at any time. For example, when the user moves, or changes a phone number, he may update his contact information. Additionally, the user's interests may change as time passes, and the user may update his interests in his profile from time to time. A user's activities on the social networking system, such as frequency of accessing particular information on the system, may also provide information that may be included in the user's profile. Again, such information may be updated from time to time to reflect the user's most-recent activities. Still further, other users or so-called friends or contacts of the user may also perform activities that affect or cause updates to a user's profile. For example, a contact may add the user as a friend (or remove the user as a friend). A contact may also write messages to the user's profile pages typically known as wall-posts. A user may also input status messages that get posted to the user's profile page.

A social network system may maintain social graph information, which can generally model the relationships among groups of individuals, and may include relationships ranging from casual acquaintances to close familial bonds. A social network may be represented using a graph structure. Each node of the graph corresponds to a member of the social network. Edges connecting two nodes represent a relationship between two users. In addition, the degree of separation between any two nodes is defined as the minimum number of hops required to traverse the graph from one node to the other. A degree of separation between two users can be considered a measure of relatedness between the two users represented by the nodes in the graph.

A social networking system may support a variety of applications, such as status updates, wall posts, geo-social networking systems, photo sharing, on-line calendars and events. Users typically navigate to various different views or pages hosted by the social networking system and/or a client application to access this functionality, either to view information or to post information relevant to a given application, such as a user profile page to update a status, or a photo upload section to upload a photo. For example, the social networking system may also include media sharing capabilities. For example, the social networking system may allow users to post photographs and other multimedia files to a user's profile, such as in a wall post or in a photo album, both of which may be accessible to other users of the social networking system. Social networking system may also allow users to configure events. For example, a first user may configure an event with attributes including time and date of the event, location of the event and other users invited to the event. The invited users may receive invitations to the event and respond (such as by accepting the invitation or declining it). Furthermore, social networking system may allow users to maintain a personal calendar. Similarly to events, the calendar entries may include times, dates, locations and identities of other users.

The social networking system may also support a privacy model. A user may or may not wish to share his information with other users or third-party applications, or a user may wish to share his information only with specific users or third-party applications. A user may control whether his information is shared with other users or third-party applications through privacy settings associated with his user profile. For example, a user may select a privacy setting for each user datum associated with the user and/or select settings that apply globally or to categories or types of user profile information. A privacy setting defines, or identifies, the set of entities (e.g., other users, connections of the user, friends of friends, or third party application) that may have access to the user datum. The privacy setting may be specified on various levels of granularity, such as by specifying particular entities in the social network (e.g., other users), predefined groups of the user's connections, a particular type of connections, all of the user's connections, all first-degree connections of the user's connections, the entire social network, or even the entire Internet (e.g., to make the posted content item index-able and searchable on the Internet). A user may choose a default privacy setting for all user data that is to be posted. Additionally, a user may specifically exclude certain entities from viewing a user datum or a particular type of user data.

A social networking system may support an online polling application. The social networking system may allow a user (e.g., a person, a business entity, an advertiser, or the social networking system itself) to create a poll for a certain subject, publish the poll to other users in the social networking system, and calculate poll results based on answers to the poll from a sample set of users. For example, an advertiser can measure preferences or attitudes toward a product (e.g., a detergent product “A”) by creating a poll comprising questions about the product (e.g., “do you use detergent A?”, “would you recommend detergent A to a friend?”), causing the social networking system to post the poll to other user's home page in the social networking system, and calculate the poll results based on the answers to the poll from a sample set of users. The polling application user interface may be included in a frame or subview of web pages hosted by the social networking system, such as embedded frames or <divs>, or as news feed entries in a news feed.

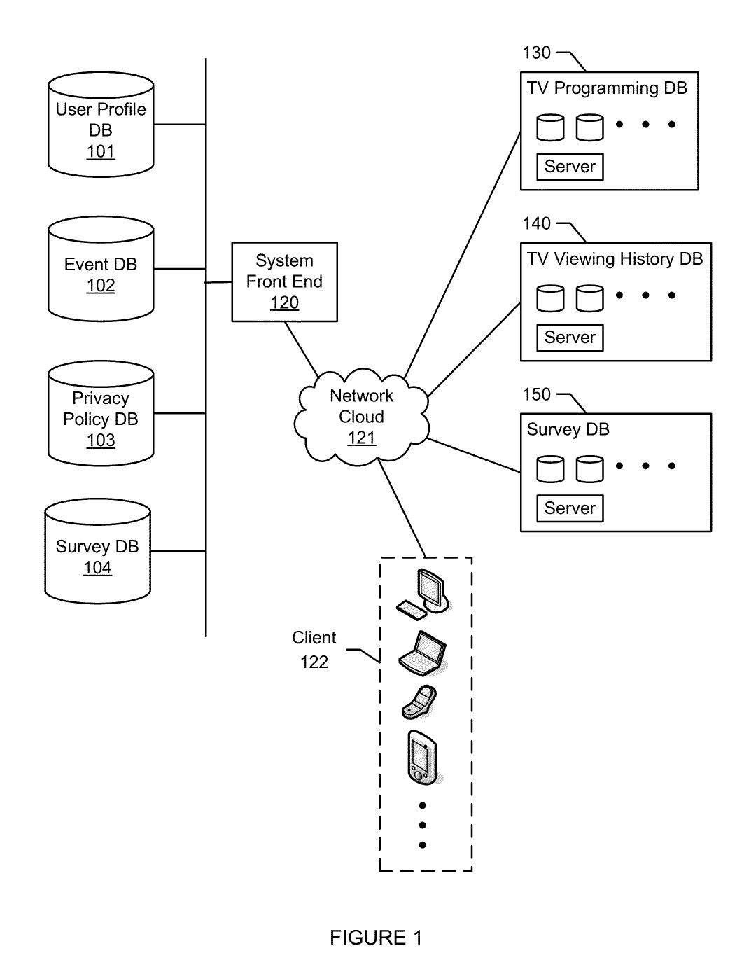

FIG. 1 illustrates an example social networking system. In particular embodiments, the social networking system may store user profile data and social graph information in user profile database 101. In particular embodiments, the social networking system may store user event data in event database 102. For example, a user may register a new event by accessing a client application to define an event name, a time and a location, and cause the newly created event to be stored in event database 102. For example, a user may register with an existing event by accessing a client application to confirm attending the event, and cause the confirmation to be stored in event database 102. In particular embodiments, the social networking system may store user privacy policy data in privacy policy database 103. In particular embodiments, the social networking system may store polls and polling results data in survey database 104. For example, a user may create an online poll, and cause the newly created poll to be stored in survey database 104. For example, the social networking system may access survey database 104 and present an online poll to one or more users, and store responses to the online poll from the one or more users in survey database 104. In particular embodiments, databases 101, 102, 103, and 104 may be operably connected to the social networking system's front end 120. In particular embodiments, the front end 120 may interact with client device 122 through network cloud 121. Client device 122 is generally a computer or computing device including functionality for communicating (e.g., remotely) over a computer network. Client device 122 may be a desktop computer, laptop computer, personal digital assistant (PDA), in- or out-of-car navigation system, smart phone or other cellular or mobile phone, or mobile gaming device, among other suitable computing devices. Client device 122 may execute one or more client applications, such as a web browser (e.g., Microsoft Windows Internet Explorer, Mozilla Firefox, Apple Safari, Google Chrome, and Opera, etc.) or special-purpose client application (e.g., Facebook for iPhone, etc.), to access and view content over a computer network. Front end 120 may include web or HTTP server functionality, as well as other functionality, to allow users to access the social networking system. Network cloud 121 generally represents a network or collection of networks (such as the Internet or a corporate intranet, or a combination of both) over which client devices 122 may access the social network system.

An advertiser may create a television (TV) advertisement (or a TV commercial) or a set of television advertisements (e.g., a TV advertising campaign) for a concept (e.g., a product, a brand, a service, etc.). An advertiser may measure an exposure rate to a television advertisement based on viewing of the advertisement and/or viewing to one or more television programs wherein the advertisement was presented. For example, Nielsen Media Research collects viewing history data from selected homes using a recording device connected to a television set in each of the selected homes. The recording device can record detailed viewing history (e.g., a particular TV program was viewed at a particular time) and transmit the recorded viewing history to one or more servers of Nielsen Media Research. An advertiser can estimate an exposure rate of a television advertisement based on the viewing history collected by Nielsen Media Research. For example, an advertiser can calculate an exposure rate to a TV advertisement as of 31 Mar. 2011 by averaging, among a set of viewers, a total number of exposures to the TV advertisement as of 31 Mar. 2011 by each of the set of viewers based on a recorded viewing history of each user. An advertiser may measure effectiveness of a TV advertisement for a concept by polling TV viewers about their preferences or attitudes toward the concept and compare the preference data with exposure rate data. However, because of the small sample size of the viewing history (e.g., very limited households are polled by Nielsen Media Research with the recording devices described above), the comparison between the preference data and the exposure rate data can be inaccurate. In addition, due to the limited demographic and other information that such systems have about these viewers, it is difficult to evaluate the other potential cause of a given users attitude toward a concept and is additionally difficult to generate control groups to compare the effect of exposure frequency of an ad to attitudes toward a concept relating to an ad. Furthermore, because a television advertisement (or a television advertising campaign) for a concept is often presented in multiple television programs during a period of time (e.g., during the week before a major sporting event), it is not feasible to prevent the advertisement from showing to a subset of viewers in order to generate a control group for measuring incremental impact of the advertisement (e.g., comparing between a first group of viewers who have seen the advertisement two times and a second group of viewers who have seen the advertisement five times).

Particular embodiments herein describe methods of modeling an exposure rate to a television advertisement for a concept for a set of users. Particular embodiments describe methods of determining effectiveness of the advertisement or advertising campaign by comparing attitudinal data toward the concept from the set of users against the exposure rate to the advertisement. Particular embodiments further describe methods of evaluating incremental impact of advertisements by comparing attitudinal data and exposure date between groups of users. In some implementations, users of the social networking system are asked episode-specific questions to determine whether each of the polled viewers has watched a particular television program. Answers to these questions can be used to determine the likelihood that a give user was either exposed or not exposed to a particular advertisement of interest that was shown during that television program. In addition, from these answers (or the inability to answer) a viewing behavior may be inferred for each of the users. In addition, the model of aggregate television viewing behavior (such as Nielsen data discussed herein) may be consulted to map exposed versus non-exposed viewers to an aggregate television viewing behavior profile (such as the number and types of television programming and, thus, the particular advertisements to which a user may have been exposed). Aggregate viewing behavior profiles then yield a number of possible exposures to a given advertisement or advertising campaign under consideration. Furthermore, those users whose answers to questions indicates that an exposure was not likely can form part of a control group relative to those users who were likely exposed. Furthermore, the user profile and other information that the social networking system has available about each user (interests, friends, etc.) can be used to either weight or filter the users in the group to ensure that the control group profile is similar to the group of likely exposed users. To generate an exposure frequency response curve, users are also asks questions designed to elicit attitudinal data related to a concept (such as a brand, product, or service).

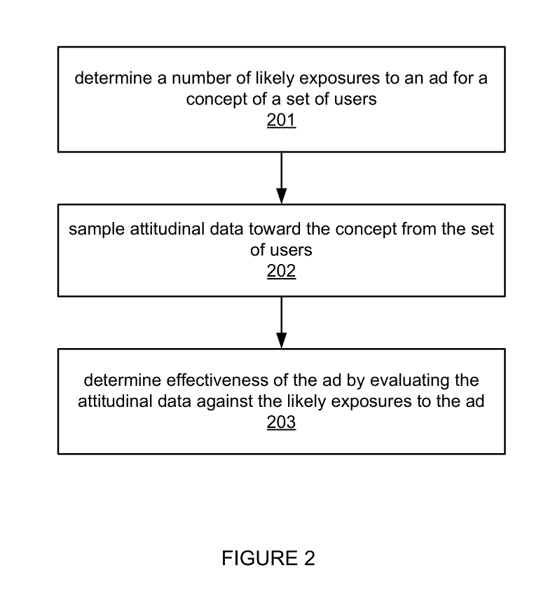

FIG. 2 illustrates an example method of determining effectiveness of a television advertisement. FIG. 2 can be implemented by an ad viewing measurement process hosted by one or more computing devices of the social networking system. In particular embodiments, the ad viewing measurement process may determine a likely number of exposures to a given television advertisement for a concept for a set of users. In particular embodiments, the ad viewing measurement process may model the viewing behavior by interacting with users in a data gathering phase to gain information that suggests the likely viewing behavior of a set of users (such as by polling users with various questions) and determining a number of likely exposures for each user of the set of users to the advertisement (201). In particular embodiments, the ad viewing measurement process may determine a number of exposures for each user of the set of users to the advertisement as of a particular period of time that the advertisement was shown during a presentation of a television program.

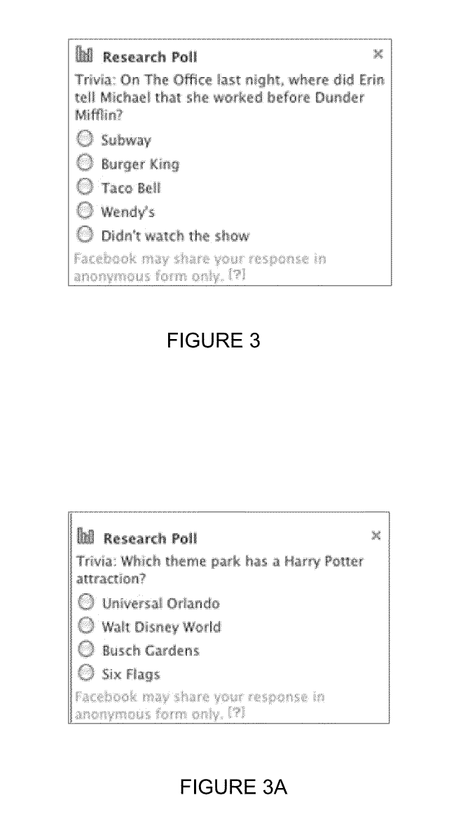

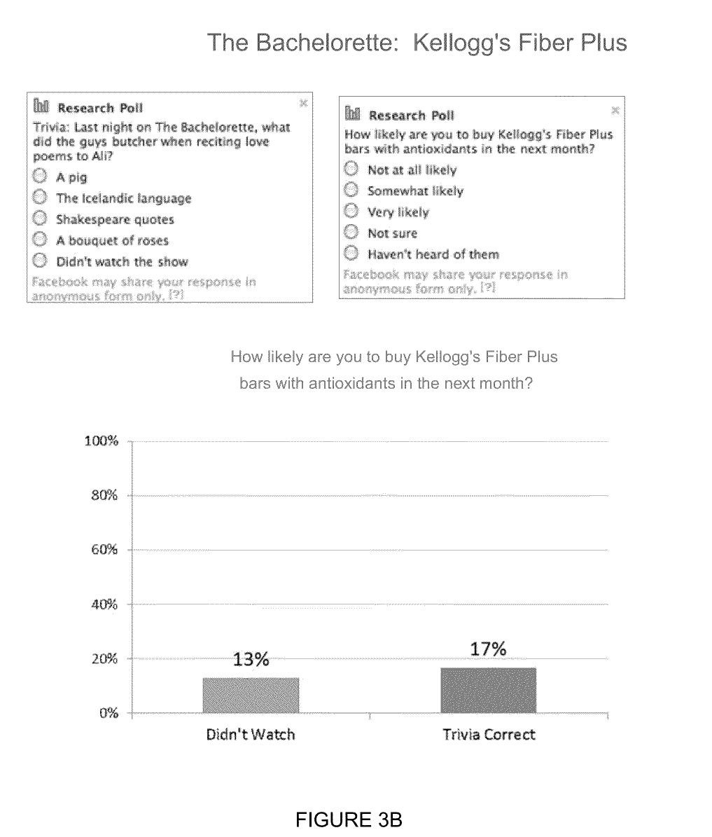

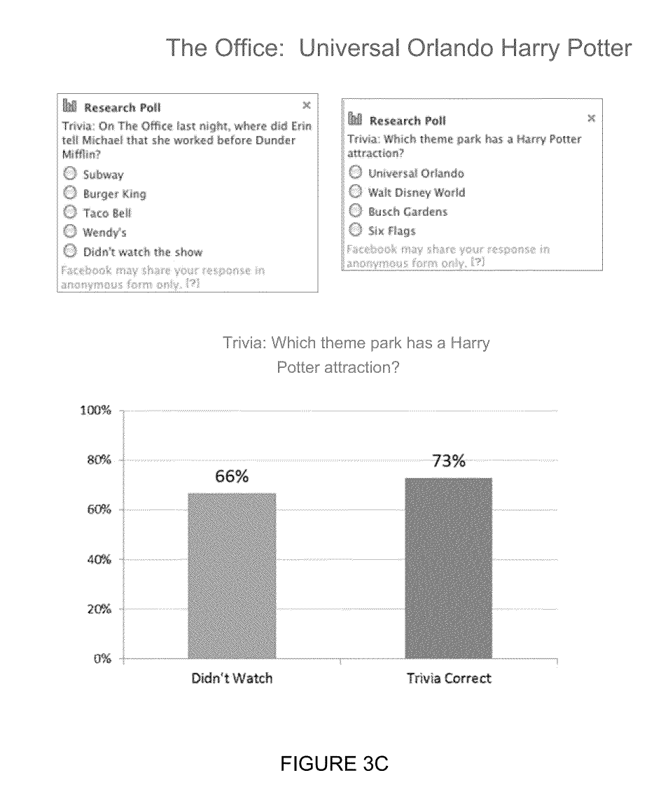

In a data gathering process or phase, the ad viewing measurement process may determine whether a user was exposed to an advertisement at the particular period of time during the presentation of the television program by presenting the user an episode-specific question or simply receiving inputs that affirmatively indicate that a user has in fact watched the episode at issue. For example, the question may relate to some element of a television program or episode, during which a particular advertisement under consideration was also run, and that was broadcast at a recent point in time to the question (such as the next day). FIG. 3 illustrates an example episode-specific question. An episode-specific question may comprise a trivia question that is specific to a scene that was shown immediately before or after the particular time period of the advertisement of interest. A correct answer to the trivia question by a user may indicate the user is most likely to have been exposed to the advertisement shown at the particular time period. An incorrect answer to the trivia question (or the inability to answer the question, such as by selecting an “I don't know” or “I didn't watch” option) by a user may indicate the user is not likely to have been exposed to the advertisement shown at that particular time period. In particular embodiments, the ad viewing measurement process, when polling users, may access survey database 104 (or a third-party survey database 150 via an API hosted by a server operatively couple to third-party survey database 150) for an episode-specific question based on the particular time period and the television program. In particular embodiments, the ad viewing measurement process may present the episode-specific question to a user and determine whether the user was likely exposed to the advertisement at the particular period of time during the presentation of the television program based on the user's answer to the episode-specific question as described above. In other embodiments, the ad viewing measurement process may access survey database 104 (or third-party survey database 150) for a series of episode-specific questions based on the particular time period and the television program, present the series of episode-specific questions to a user, and determine whether the user was exposed to the advertisement at the particular period of time during the presentation of the television program based on the user's answers to the series of episode-specific questions. For example, the ad viewing measurement process may determine that a user was exposed to the advertisement at the particular period of time during the presentation of the television program if the user answers correctly four out of five episode-specific questions. In one embodiment, the ad viewing measurement process may determine whether a user was exposed to the advertisement at the particular period of time during the presentation of the television program by presenting the user a direct question, such as “Did you watch the advertisement at this particular period of time during this television program?” In yet other embodiments, the polling questions may also include questions (either explicit or episode-specific) that confirm whether the user did not watch the instance of the advertisement in question. For example, a user may be asked whether the user viewed a television program during which the advertisement at issue was not aired. In some implementations, the polling questions for a given user can be selected based on a user profile, the user's past answers to previous polls, declarations of affinity to particular television programs and the like. In particular embodiments, the ad viewing measurement process may access one or more data stores of television programming information for a particular period of time when the advertisement was displayed during a presentation of a television program. For example, the ad viewing measurement process may access a television programming database 130 via an application programming interface (API) hosted by a server operatively coupled to the television programming database 130, as illustrated in FIG. 1.

Other processes may be used in addition to, or in lieu of, episode-specific questions. In one embodiment, the ad viewing measurement process may determine whether a user was exposed to the advertisement at the particular period of time during the presentation of the television program by accessing the user's television viewing history. For example, the user can be a TV viewer participating in the viewing history collection system run by Nielsen Media Research described above. In other implementations, the user may watch television programs provided by online video service providers (e.g., Hulu, Netflix, or ESPN3) and the user's viewing history of the online video contents can be stored in one or more servers of the online video service providers. Yet in another embodiment, the ad viewing measurement process may access user profile database 101 and event database 104 for data indicating a user's exposure to the advertisement or to the television program (e.g., the user may have a status update “watching this particular TV show right now” with a corresponding time stamp, the user may have an event “watching this particular TV show with a friend” with a corresponding event time).

In some embodiments, a user may check in to an episode of a television program and store the television check-in activity in the social networking system (or a third-party viewing history database). The ad viewing measurement process may determine whether a user was exposed to an advertisement at a particular period of time during presentation of a television program by accessing the user's television check-in activities stored in the social networking system (or a third-party viewing history database). For example, a user may access a special-purpose application hosted by the user's client device 122 while watching television, causing the special-purpose application to determine a particular episode of a particular television program that the user is watching (e.g., by comparing audio or sub-audible tones of the television program to an audio database of television programs) and display in the special-purpose application's graphical user interface a selectable icon “watching now” and content related to the particular television program. The user can select the “watching now” icon, causing the special-purpose application to transmit to the social networking system an indication of the user's television check-in activity of the particular episode of the particular television program and a time stamp. A server-side process of the social networking system can store the user's television check-in activity in event database 102, and additionally publish the television check-in activity to the user's profile page (e.g., “John is watching CSI right now.”). For example, a user may select a “watching now” icon in a web page of a television program displayed in a graphical user interface of an application (e.g., a web browser) of the user's client device 122, causing the application to transmit to the social networking system an indication of the user's television check-in activity and a time stamp, to be stored in event database 102 as described above. For example, a user may access a special-purpose application hosted by the user's GPS-equipped mobile device while watching television, causing the special-purpose application to determine a current time (e.g., via s system call) and a current location (e.g., current GPS coordinates), access television programming database 130 (e.g., via an API hosted by a server operatively coupled to the television programming database 130) for a list of current television programs based on the current location and the current time, and present the list of current television programs to the user in a graphical user interface of the special-purpose application. The user may select a “watching now” icon displayed with content of a particular television program from the list of current television programs, causing the special-purpose application to transmit to the social networking system an indication of the user's television check-in activity for the particular television program and a time stamp, to be stored in event database 102 as described above.

From the data gathered by the process, the ad viewing measurement process may separate users into a group of users that are likely to have been exposed to the instance of the advertisement at issue (hereinafter the “exposed group”) and a control group of users that are not likely to have been exposed. In some implementations, the ad viewing measurement process uses the likely exposure determination and the user's expressed viewing behavior as revealed by answers to questions posed as a signal of a likely television viewing behavior in an aggregate sense. In particular embodiments, the ad viewing measurement process may determine a number of likely exposures to the advertisement or ad campaign for each of the exposed group and the control group.

In some implementations, the ad viewing measurement process assigns a television viewing profile to each user of the exposed group and the control group. Each television viewing profile is based on aggregate viewing histories gathered from monitoring viewing behavior of a set of individuals, such as the Nielsen Media Research systems, as discussed below. As one skilled in the art will recognize, a given advertisement or campaign may be aired across multiple different channels and during a variety of different programming. Accordingly, that a particular user was not exposed to a particular instance of an advertisement does not mean that such user has not been exposed to other instances of the advertisement at other times. Data from Nielsen Media Research or other systems contains more detail about the viewing behaviors of a limited set of viewers, such as a detailed history of the television programming (and thus advertising) a viewer has watched. From this data, television viewing profiles tied to gender, age and possibly different demographic attributes can be developed. The television viewing profiles can be searched against an advertisement or advertising campaign (optionally time limited to a threshold period of time) to identify a number of likely exposures to an advertisement or campaign.

As discussed above, a data store storing television viewing history may comprise viewing history of a plurality of viewers collected from a recording device coupled to a television set of each of the plurality of users as described above in the Nielsen Media Research system. A data store storing television viewing history may comprise data collected from viewing history data of content distributed online (e.g., content distributed by online video services such as Hulu, Netflix, or ESPN3). For example, the ad viewing measurement process may access user profile database 101 and event database 104 for viewing history based on data indicating one or more users' exposure to the advertisement (e.g., a status update “watching a particular TV show right now” with a corresponding time stamp, an event “watching a particular TV show with a friend” with a corresponding event time).

In particular embodiments, the ad viewing measurement process may determine a number of likely exposures to the advertisement between the exposed group and the control group. In one implementation, the ad viewing measurement process calculates an average cumulative exposure frequency to the advertisement based on the television viewing profiles (see above) mapped to the users in the exposed and control groups. As discussed above, each viewing profile can be based on a set of representative television viewing histories obtained from the Nielsen Media Research system or some other tracking source. These detailed viewing histories can be aggregated to determine an average cumulative number of exposures to a given advertisement or ad campaign over a defined period of time. In some implementations, the ad viewing measurement process maps users in each of the exposed and control group to viewing profile histories based on indications whether the users watched a particular television program (such as a program during which the instance of the ad under analysis was aired, a different program aired at the same or another time during which the ad under analysis was not aired, and the like). The ad viewing measurement process, for example, may identify the television viewing histories obtained from an external source (such as Nielsen Media Research) and identify those histories that include the respective programs that each of the users is likely to have watched. For example, if a user or set of users answers questions indicating that each has watched a program called “Diners, Drive-Ins & Dives” at a given day and time, the ad viewing measurement process may search the viewing history database to identify a profile or a set of viewing histories that match. The ad viewing measurement process may then determine an average number of exposures to an advertisement or campaign at issue (either for the exposed or control group) by searching for the advertisement(s) in the viewing histories and computing an average number of times across the matching viewing histories the advertisements appeared. This search can be limited to a configurable period of time. Application of the process to both the exposed and control groups yields a cumulative average number of exposures for the exposed group and the control group. In some implementations, probability density functions can be constructed based on the viewing history profiles that return a likely number of exposures to a given advertisement based on the determined viewing profile of a user elicited from the polling questions. For example, the ad viewing measurement process may identify a set of users who had watched a particular advertisement (e.g., an ad for Toyota Prius) during a particular television program (e.g., “Monday Night Football”). The ad viewing measurement may then identify all of the other times (over a given time period) that the particular ad appeared. Because each individual user of the set of users may have watched different sets of television programs, there is not a single number of exposures to the particular advertisement between the set of users. Instead, the ad viewing measurement process may construct a probability density function for number of exposures to the particular advertisement (e.g., X% of users were exposed for 1 time, Y% of users were exposed for 2 times, etc.). The benefit of the probability density function is that it allows to compute an expected value (similar to an average) and to compute how well the average describes the population. For example, an expected value of 5 exposures with 90% of users being within 1 exposure of each other may indicate a high confidence in that expected value. However, if only 5% of users being within 3 exposures of an expected value of 5 exposures may indicate a low confidence in that expected value.

In particular embodiments, the ad viewing measurement process may access attitudinal data corresponding to the users in the exposed and control group toward a concept related to the advertisement or advertising campaign under consideration (202). In particular embodiments, the ad viewing measurement process may access survey database 104 (or third-party survey database 150) for one or more attitudinal questions related to the concept. FIG. 3A illustrates an example attitudinal question. An attitudinal question may be a question about preference, awareness, and/or intent (e.g., future purchase decision) toward the concept. In particular embodiments, the ad viewing measurement process may sample attitudinal data among the set of users toward the concept by presenting the one or more attitudinal questions toward the concept to each of the set of users. In particular embodiments, the ad viewing measurement process may store attitudinal data toward the concept comprising responses to the one or more attitudinal question from each of the set of users, in survey database 104 (or third-party survey database 150). In some implementations, polling users to gather attitudinal data may be performed in connection with the polling processes, discussed above, to identify likely exposures to advertisements. For example, the polling questions directed to obtaining attitudinal data may be posed concurrently with the polling questions directed to ascertaining likely exposures to advertisements. In other implementations, the polling questions may be posed to users at a later time.

The polling questions may be designed to elicit attitudinal data concerning a concept associated with the advertisement or campaign at issue, such as a brand, a product or a service. The polling questions can ask whether a user is likely to purchase a product, whether a user has a favorable opinion about a brand, whether a user is aware of a brand, whether a user is aware of a product (or attributes of a product), whether a user prefers the a brand/product over a competitor's brand/product, and the like. In other implementations, other sources of attitudinal data can be used, such as offline surveys, telephonic surveys, and the like.

In particular embodiments, the ad viewing measurement process may determine effectiveness of the advertisement by evaluating the attitudinal data against the number of likely exposures to the advertisement (203). In particular embodiments, the ad viewing measurement process may determine effectiveness of the advertisement by comparing exposure frequency and attitudinal data between of the exposed group users and the control group users. For example, assume for didactic purposes, that the average cumulative exposure frequency of an advertisement for a product was 3.5 for the control group and 5.1 for the exposed group. Further assume that thirty percent of the control group responded positively to an attitudinal question, such as expressing an intent to purchase an advertised product or a favorable opinion of a brand. Further assume that fifty-three percent of the exposed group also responded positively to the attitudinal question. FIGS. 3B and 3C illustrate example bar graphs that can be displayed to reveal the differences between the exposed and control groups. That is, the TV commercial can be effective in persuading a majority of TV viewers toward the product over the competing product after the TV commercial is shown to a TV viewer for about five times. For example, the ad viewing measurement process may determine a third set of users having an exposure frequency of 8.3 times to the TV commercial while 60% of the third set of users prefer the product over the competing product. That is, the TV commercial's effectiveness in persuading TV viewers toward the product may level off when the TV commercial is shown to a TV viewer for about eight times.

The foregoing illustrates operation of an embodiment where it is assumed that users have been previously exposed to the advertisement or campaign under consideration. In such a situation, the data generated by the ad viewing measurement process allows for insights into the incremental differences of the likely ad exposures between the control and exposed groups. In another potential use of the invention, knowledge about an upcoming television ad campaign would allow for collection of baseline information from the television programs that will contain the TV advertisements under consideration at a later date. For example, if Nissan Leaf commercials will run on Modern Family on ABC in week 2, the ad viewing measurement process may poll users for viewership (exposure) and brand (attitudinal) metrics for Nissan Leaf in week 1. This enables control for audience and generates a set of respondents no exposure to the advertisement or campaign under consideration as an initial control group. In some situations, this analysis scenario may be difficult to achieve, if the TV campaign is ongoing or if the system lacks the information about where and when television ad exposures will occur.

In that case, the system may use the methodology described herein to create two different types of control groups. A first control group may be created by identifying television programs where a large percentage of viewers have likely had no exposure to the advertisements at issue. For example, if Nissan runs the Leaf commercial on Modern Family in week 2, the system could also collect poll respondents who reported watching America's Next Top Model on the CW the same night, since the two shows appear simultaneously. Use of exposure history data from the Nielsen Media Research panel would indicate that the majority of viewers of America's Next Top Model did not see the Leaf commercial and thus can be used as a control group with expected ad exposure values of zero. As the ad campaign grows in size and/or duration, however, advertisers may want to know the value of incremental ad exposure (e.g., 1 vs. 2, 5 vs. 8, etc). In these cases, the system may use the same methodology to identify poll respondents via self-reported show viewership and apply the methodology discussed above to assign an expected value of previous ad exposure to viewers in each of the control and exposed groups. For example, as discussed above, if the system determines that on the same date Modern Family viewers had an expected exposure frequency of 6, but American Idol viewers had an expected exposure frequency of 5, the system could compare the impact of 5 vs. 6 ad exposures. In some implementations, the processes described herein can be repeatedly executed to generate a time series of data that advertisers can view to show the effectiveness of an ad campaign over time.

Furthermore, in particular embodiments, the ad viewing measurement process may perform some or all of the following operations to create or analyze the control group. One challenge with TV research is that various TV shows have substantially different demographics and psychographics. Thus, comparing the brand awareness for Nissan Leaf, for example, among who watched Modern Family against those who did not watch Modern Family may result in two groups who differ substantially even before TV ad exposure. In some implementations, the ad viewing measurement process may access the rich user profile data maintained by the social networking system (such as user profile data: age, gender, location, etc.) and employ user-level data to create comparable comparison groups between the exposed and control groups. For example, one possible adjustment may be based on demographic information. For example, the ad viewing measurement process may adjust the composition of one or both of the control and exposure groups such that the demographic makeup of the groups are substantially the same. Another possible adjustment may be based on the declared interests of individuals. For example, the interests or other social factors of the individuals in the exposed group may differ from the control group. For example, the audience for a car commercial aired during a televised NASCAR event may be comprised of people much more knowledgeable about cars than one that appeared on Modern Family. The rich information about users interests and behaviors available on the social networking system can be applied to the comparison groups to ensure that the two are roughly equivalent. For example, the system could assess the average number of automotive pages “Liked” by users in each group, and weight or otherwise model the groups to be equivalent.

Demographic factors may comprise gender, age group (e.g., 18 to 25 years old, 25 to 45 years old, etc.), education (e.g., high school graduates, college graduates, etc.), family status, and marital status. Social factors may comprise interest (e.g., sport, music, books, movies, food, etc.), work information, schools a user attended, events a user attends, social contacts, pages that a user has liked or otherwise declared an affinity, and the like. For example, the ad viewing measurement process may access user profile database 101 and event database 102, based on user identifiers of users of the exposed and control groups, for demographic and social information. The ad viewing measurement process may construct a group profile for each of the exposed and control groups based on the demographic and social information. For example, a group profile for the exposed group may comprise 70% male and 30% female, and 60% of those users may be interested in a particular sports team. The exposed group may have an exposure frequency of 7.1 times to a TV commercial for an apparel brand and attitudinal data of 60% of users being aware of the brand. A group profile for the control group may comprise 35% male and 65% female, with 40% of users being interested in the particular sports team. The second set of users may have an exposure frequency of 4.2 times to the TV commercial and attitudinal data of 20% of users being aware of the brand. The ad viewing measurement process may adjust the control and exposed groups. For example, the ad viewing measurement process may select a subset of users of the exposed or control group, to render the groups the substantially the same along demographic attributes and/or social information.

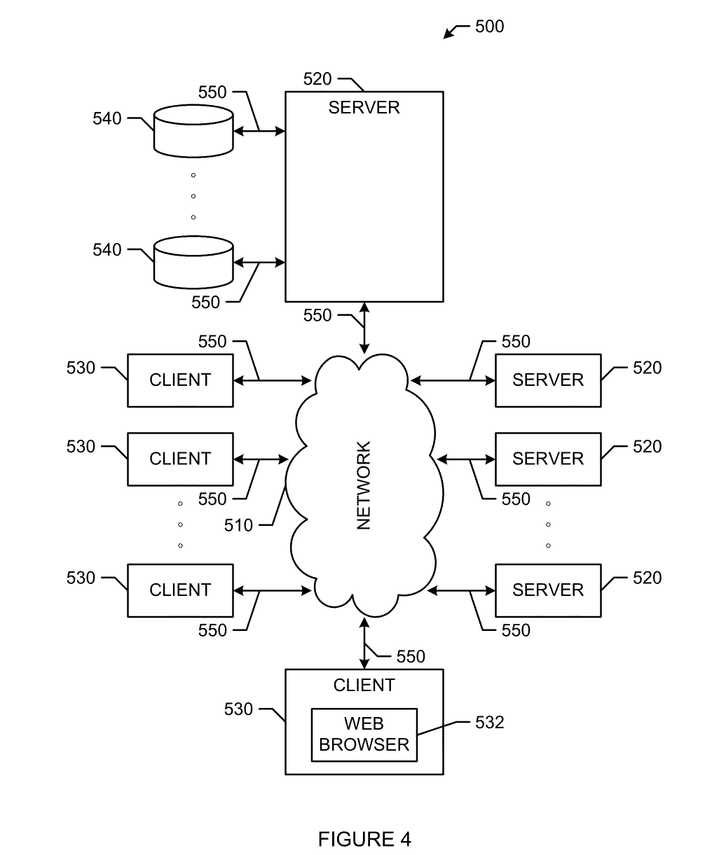

While the foregoing embodiments may be implemented in a variety of network configurations, the following illustrates an example network environment for didactic, and not limiting, purposes. FIG. 4 illustrates an example network environment 500. Network environment 500 includes a network 510 coupling one or more servers 520 and one or more clients 530 to each other. Network environment 500 also includes one or more data storage 540 linked to one or more servers 520. Particular embodiments may be implemented in network environment 500. For example, social networking system frontend 120 may be written in software programs hosted by one or more servers 520. For example, event database 102 may be stored in one or more storage 540. In particular embodiments, network 510 is an intranet, an extranet, a virtual private network (VPN), a local area network (LAN), a wireless LAN (WLAN), a wide area network (WAN), a metropolitan area network (MAN), a portion of the Internet, or another network 510 or a combination of two or more such networks 510. The present disclosure contemplates any suitable network 510. One or more links 550 couple a server 520 or a client 530 to network 510. In particular embodiments, one or more links 550 each includes one or more wired, wireless, or optical links 550. In particular embodiments, one or more links 550 each includes an intranet, an extranet, a VPN, a LAN, a WLAN, a WAN, a MAN, a portion of the Internet, or another link 550 or a combination of two or more such links 550. The present disclosure contemplates any suitable links 550 coupling servers 520 and clients 530 to network 510.

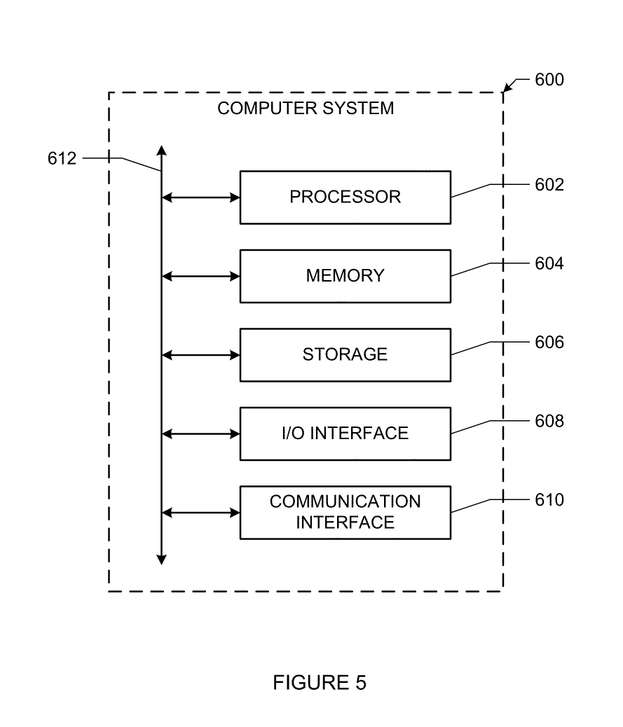

FIG. 5 illustrates an example computer system 600, which may be used with some embodiments of the present invention. This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 600 may include one or more computer systems 600; be unitary or distributed; span multiple locations; span multiple machines; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM.

In particular embodiments, storage 606 includes mass storage for data or instructions. As an example and not by way of limitation, storage 606 may include an HDD, a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these.

In particular embodiments, I/O interface 608 includes hardware, software, or both providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network (such as, for example, a 802.11a/b/g/n WI-FI network, a 802.11s mesh network), a WI-MAX network, a cellular telephone network (such as, for example, a Global System for Mobile Communications (GSM) network, an Enhanced Data Rates for GSM Evolution (EDGE) network, a Universal Mobile Telecommunications System (UMTS) network, a Long Term Evolution (LTE) network), or other suitable wireless network or a combination of two or more of these.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, a Universal Asynchronous Receiver/Transmitter (UART) interface, a Inter-Integrated Circuit (I²C) bus, a Serial Peripheral Interface (SPI) bus, a Secure Digital (SD) memory interface, a MultiMediaCard (MMC) memory interface, a Memory Stick (MS) memory interface, a Secure Digital Input Output (SDIO) interface, a Multi-channel Buffered Serial Port (McBSP) bus, a Universal Serial Bus (USB) bus, a General Purpose Memory Controller (GPMC) bus, a SDRAM Controller (SDRC) bus, a General Purpose Input/Output (GPIO) bus, a Separate Video (S-Video) bus, a Display Serial Interface (DSI) bus, a Advanced Microcontroller Bus Architecture (AMBA) bus, or another suitable bus or a combination of two or more of these. Bus 612 may include one or more buses 612, where appropriate.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method, comprising:
modeling viewing behavior of a set of users, the viewing behavior for each user indicating a number of likely exposures to an advertisement for a concept;
accessing attitudinal data from the set of users toward the concept of a plurality of users; and
determining effectiveness of the advertisement by evaluating the attitudinal data against the number of likely exposures to the advertisement.

2. The method of claim 1, wherein the modeling viewing behavior of a set of users, the viewing behavior for each user indicating a number of likely exposures to an advertisement for a concept, further comprises:
accessing data indicating a particular period of time when the advertisement was displayed during a presentation of a television program;
accessing one or more data stores to generate a set of viewers based on exposure to the advertisement at the particular period of time during the presentation of the television program, wherein each of the set of viewers having a record of television viewing history; and
determining the number of likely exposures to the advertisement by calculating an average cumulative number of exposures to the advertisement based on the record of television viewing history of the set of viewers.

3. The method of claim 2, wherein the record of television viewing history further comprises one or more television check-in activities.

4. The method of claim 2, further comprising:
constructing a probability density function for the number of likely exposures to the advertisement based on the record television viewing history of the set of viewers.

5. The method of claim 1, wherein the determining effectiveness of the advertisement by evaluating the attitudinal data against the number of likely exposures to the advertisement, further comprises:
modeling a number of likely exposures of a first set of users and sampling a first attitudinal data toward the concept from the first set of users;
modeling a second number of likely exposures of a second set of users and sampling a second attitudinal data toward the concept from the second set of users; and
comparing a difference between the first and the second attitudinal data and a difference between the first viewing behavior and the second viewing behavior.

6. The method of claim 5, further comprising:
adjusting the first attitudinal data by matching the first set of users to the second set of users based on demographic factors.

7. The method of claim 5, further comprising:
adjusting the first attitudinal data by matching the first set of users to the second set of users based on social factors.

8. One or more computer-readable tangible storage media embodying software operable when executed by one or more computing devices to:
model viewing behavior of a set of users, the viewing behavior for each user indicating a number of likely exposures to an advertisement for a concept;
access attitudinal data from the set of users toward the concept of a plurality of users; and
determine effectiveness of the advertisement by evaluating the attitudinal data against the number of likely exposures to the advertisement.

9. The media of claim 8, wherein to model viewing behavior of a set of users, the viewing behavior for each user indicating a number of likely exposures to an advertisement for a concept, further comprises software operable when executed by the one or more computing devices to:
access data indicating a particular period of time when the advertisement was displayed during a presentation of a television program;
access one or more data stores to generate a set of viewers based on exposure to the advertisement at the particular period of time during the presentation of the television program, wherein each of the set of viewers having a record of television viewing history; and
determine the number of likely exposures to the advertisement by calculating an average cumulative number of exposures to the advertisement based on the record of television viewing history of the set of viewers.

10. The media of claim 9, wherein the record of television viewing history further comprises one or more television check-in activities.

11. The media of claim 9, further comprising software operable when executed by the one or more computing devices to:
construct a probability density function for the number of likely exposures to the advertisement based on the record television viewing history of the set of viewers.

12. The media of claim 8, wherein to determine effectiveness of the advertisement by evaluating the attitudinal data against the number of likely exposures to the advertisement, further comprises software operable when executed by the one or more computing devices to:
model a number of likely exposures of a first set of users and sampling a first attitudinal data toward the concept from the first set of users;
model a second number of likely exposures of a second set of users and sampling a second attitudinal data toward the concept from the second set of users; and
compare a difference between the first and the second attitudinal data and a difference between the first viewing behavior and the second viewing behavior.

13. The media of claim 12, further comprising software operable when executed by the one or more computing devices to:
adjust the first attitudinal data by matching the first set of users to the second set of users based on demographic factors.

14. The media of claim 12, further comprising software operable when executed by the one or more computing devices to:
adjust the first attitudinal data by matching the first set of users to the second set of users based on social factors.

15. A system comprising:
a memory;
one or more processors; and
a non-transitory, storage medium storing computer-readable instructions operative, when executed, to cause the one or more processors to:
model viewing behavior of a set of users, the viewing behavior for each user indicating a number of likely exposures to an advertisement for a concept;
access attitudinal data from the set of users toward the concept of a plurality of users; and
determine effectiveness of the advertisement by evaluating the attitudinal data against the number of likely exposures to the advertisement.

16. The system of claim 15, wherein to model viewing behavior of a set of users, the viewing behavior for each user indicating a number of likely exposures to an advertisement for a concept, further comprises instructions operable to cause the one or more processors to:
access data indicating a particular period of time when the advertisement was displayed during a presentation of a television program;
access one or more data stores to generate a set of viewers based on exposure to the advertisement at the particular period of time during the presentation of the television program, wherein each of the set of viewers having a record of television viewing history; and
determine the number of likely exposures to the advertisement by calculating an average cumulative number of exposures to the advertisement based on the record of television viewing history of the set of viewers.

17. The system of claim 15, wherein the record of television viewing history further comprises one or more television check-in activities.

18. The system of claim 15, further comprising instructions operable to cause the one or more processors to:
construct a probability density function for the number of likely exposures to the advertisement based on the record television viewing history of the set of viewers.

19. The system of claim 15, wherein to determine effectiveness of the advertisement by evaluating the attitudinal data against the number of likely exposures to the advertisement, further comprises instructions operable to cause the one or more processors to:
model a number of likely exposures of a first set of users and sampling a first attitudinal data toward the concept from the first set of users;
model a second number of likely exposures of a second set of users and sampling a second attitudinal data toward the concept from the second set of users; and
compare a difference between the first and the second attitudinal data and a difference between the first viewing behavior and the second viewing behavior.

20. The system of claim 19, further comprising instructions operable to cause the one or more processors to:
adjust the first attitudinal data by matching the first set of users to the second set of users based on demographic factors.

21. The system of claim 19, further comprising instructions operable to cause the one or more processors to:
adjust the first attitudinal data by matching the first set of users to the second set of users based on social factors.
